(19) United States
(12) Patent Application Publication
(10) Pub. No.: US 2025/0123245 A1
(43) Pub. Date: Apr. 17, 2025

(54) ULTRASONIC MODULE AND ULTRASONIC PROBE HAVING THE SAME

(71) Applicant: Qisda Corporation, Taoyuan City (TW)

(72) Inventor: Fu-Sheng JIANG, Taoyuan City (TW)

(73) Assignee: Qisda Corporation, Taoyuan City (TW)

(21) Appl. No.: 18/888,366

(22) Filed: Sep. 18, 2024

(30) Foreign Application Priority Data
Oct. 16, 2023 (TW) 112139358

(51) Int. Cl. G01N 29/24; G10K 11/00

(52) U.S. Cl. CPC G01N 29/2418; G10K 11/004

(57) ABSTRACT

The present disclosure is related to an ultrasonic module and an ultrasonic probe having the same. The ultrasonic module comprises a frame component, an ultrasonic oscillating component, an acoustic lens and an adhesive component. The ultrasonic oscillating component is accommodated in the frame component. The acoustic lens is disposed on the frame component. The adhesive component is accommodated in the frame component. The frame component is disposed between the acoustic lens and the ultrasonic oscillating component. The frame component has a first opening 10 formed at one end adjacent to the acoustic lens. The ultrasonic oscillating component is disposed on a side of the first opening close to the adhesive component. The acoustic lens is in contact with the ultrasonic oscillating component through the first opening.

This application claims the benefit of Taiwan application Serial No. 112139358 filed on Oct. 16, 2023, the subject matter of which is incorporated herein by reference.

### FIELD OF THE INVENTION

The invention relates in general to an ultrasonic module and an ultrasonic probe having the same.

### DESCRIPTION OF THE PRIOR ART

Generally speaking, a transduction signal line of an ultrasonic transducer is normally packaged at a side of the ultrasonic transducer close to an object to be tested (such as a human body). Due to such design, ultrasonic testing is susceptible to the interference of the electromagnetic signals of the object to be tested and the interference of the electromagnetic signals of the external environment.

Therefore, it has become a prominent task for the industries in the technical field to provide a solution for solving the problems described above.

### SUMMARY OF THE INVENTION

According to one embodiment of the present invention, an ultrasonic module is provided. The ultrasonic module comprises a frame component, an ultrasonic oscillating component, an acoustic lens and an adhesive component. The ultrasonic oscillating component is accommodated in the frame component. The acoustic lens is disposed on the frame component. The adhesive component is accommodated in the frame component. The frame component is disposed between the acoustic lens and the ultrasonic oscillating component. The frame component has a first opening formed at one end adjacent to the acoustic lens. The ultrasonic oscillating component is disposed on a side of the first opening close to the adhesive component. The acoustic lens is in contact with the ultrasonic oscillating component through the first opening.

According to another embodiment of the present invention, an ultrasonic probe is provided. The ultrasonic probe comprises an ultrasonic module and a casing. The ultrasonic module comprises a frame component, an ultrasonic oscillating component, an acoustic lens and an adhesive component. The ultrasonic oscillating component is accommodated in the frame component. The acoustic lens is disposed on the frame component. The adhesive component is accommodated in the frame component. The frame component is disposed between the acoustic lens and the ultrasonic oscillating component. The frame component has a first opening formed at one end adjacent to the acoustic lens. The ultrasonic oscillating component is disposed on a side of the first opening close to the adhesive component. The acoustic lens is in contact with the ultrasonic oscillating component through the first opening. The casing covers the ultrasonic module and partially exposes the acoustic lens.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A to 1B are schematic diagrams of an ultrasonic module according to an embodiment;

FIG. 2 is an explosion diagram of an ultrasonic module;

FIG. 3 is a top view cross-section of an ultrasonic module;

FIG. 4 is a schematic diagram of a frame component of an ultrasonic module;

FIG. 5 is a schematic diagram of an ultrasonic probe according to an embodiment; and

FIG. 6 is a top view cross-section of an ultrasonic probe.

### DETAILED DESCRIPTION

Detailed descriptions of each embodiment of the present invention are disclosed below with reference to accompanying drawings. Apart from the said detailed descriptions, any embodiments in which the present invention can be used as well as any substitutions, modifications or equivalent changes of the said embodiments are within the scope of the present invention, and the descriptions and definitions in the claims shall prevail. Moreover, generally known procedures or elements are not disclosed to avoid adding unnecessary restrictions to the present invention. Unless otherwise specified, element designations common to different drawings can be regarded as corresponding elements.

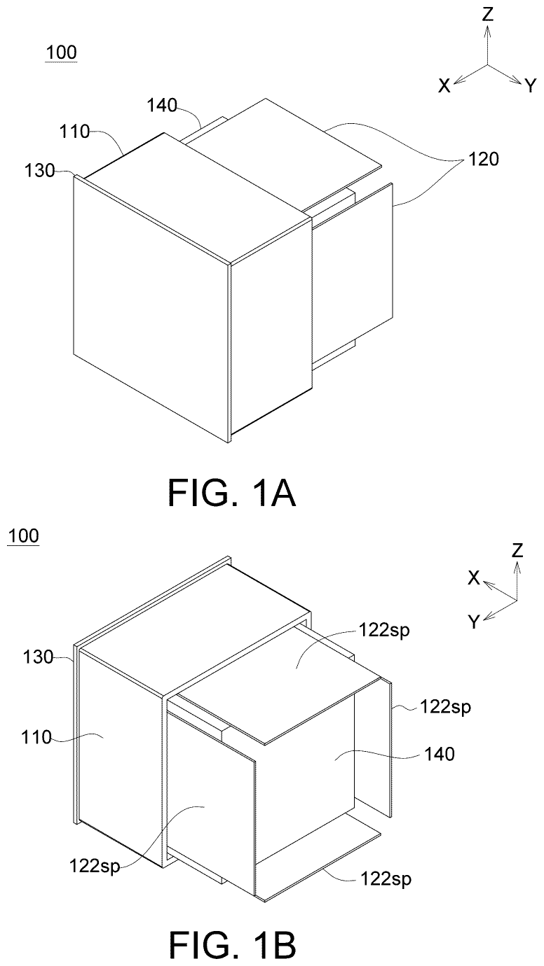

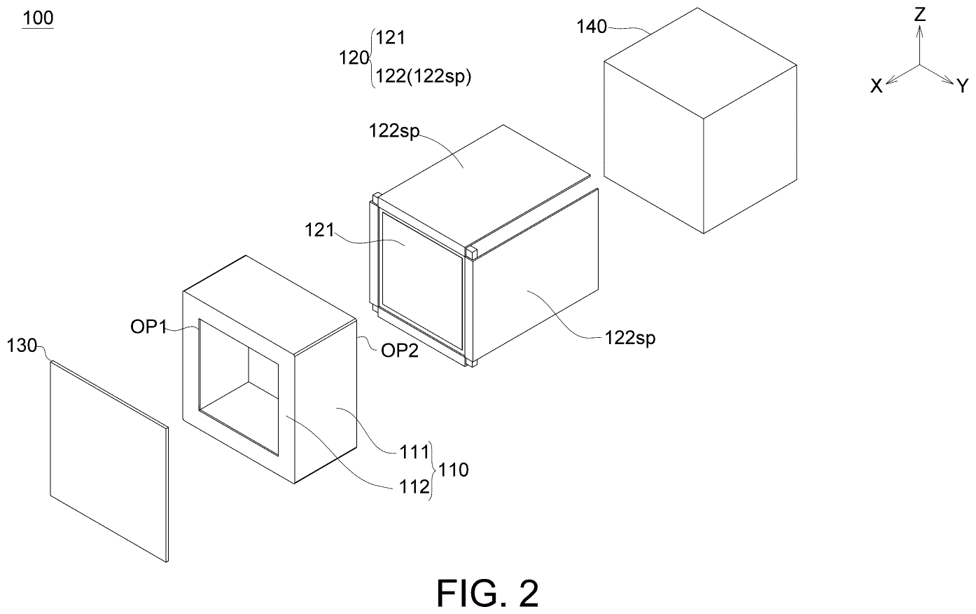

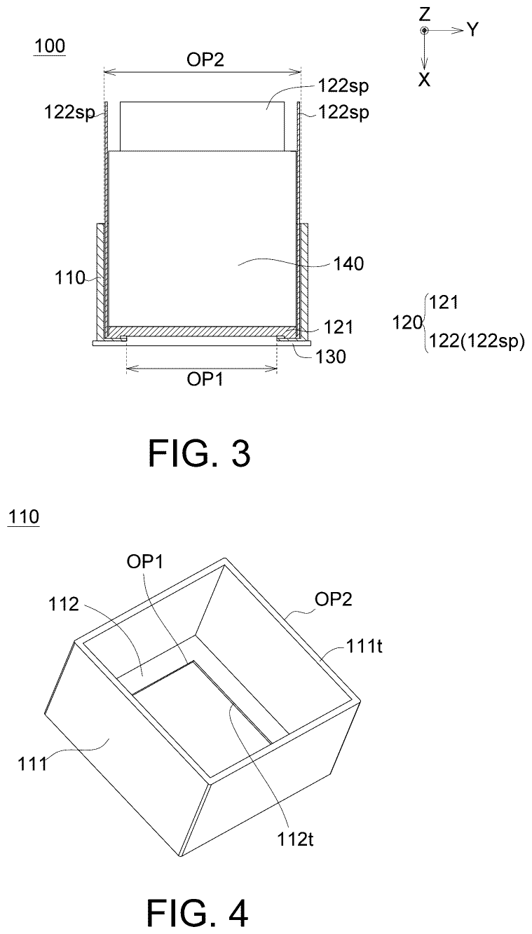

Refer to FIGS. 1A, 1B, 2 and 3. FIGS. 1A to 1B are schematic diagrams of an ultrasonic module 100 according to an embodiment. FIG. 2 is an explosion diagram of an ultrasonic module along the X-axis. FIG. 3 is a top view cross-section of an ultrasonic module along the Z-axis.

The ultrasonic module 100 can be used in an ultrasonic transducer. The ultrasonic module 100 comprises a frame component 110, an ultrasonic oscillating component 120, an acoustic lens 130 and an adhesive component 140. The frame component 110 can be used as an anti-electromagnetic interference (anti-EMI) component in the ultrasonic module 100. For example, the frame component 110 may be integrally formed of metal in one piece. The ultrasonic oscillating component 120 is accommodated in the frame component 110. The acoustic lens 130 may be formed of silicon or glass. The acoustic lens 130 is disposed on the frame component 110. The adhesive component 140 is accommodated in the frame component 110. The frame component 110 is disposed between the acoustic lens 130 and the ultrasonic oscillating component 120. In an embodiment as indicated in FIG. 3, the adhesive component 140 and the acoustic lens 130 are disposed on two opposite sides with respect to the ultrasonic oscillating component 120; the acoustic lens 130 is disposed under the ultrasonic oscillating component 120 along the X-axis; and the adhesive component 140 is disposed above the ultrasonic oscillating component 120 along the X-axis.

The frame component 110 comprises a peripheral portion 111 and an inner extension portion 112 connected to the peripheral portion 111. The frame component 110 has a first opening OP1 formed at one end adjacent to the acoustic lens 130. To put it in greater details, the inner extension portion 112 has a first opening OP1 formed corresponding to the end adjacent to the acoustic lens 130. The ultrasonic oscillating component 120 is disposed on a side of the first opening OP1 close to the adhesive component 140. The acoustic lens 130 and the ultrasonic oscillating component 120 are respectively disposed on two sides of the first opening OP1. The acoustic lens 130 can be in contact with the ultrasonic oscillating component 120 through the first opening OP1.

The ultrasonic oscillating component 120 and the adhesive component 140 can be accommodated in an interior volume surrounded and defined by the peripheral portion 111. Through the composition of the peripheral portion 111 and the inner extension portion 112, the ultrasonic oscillating component 120 and the adhesive component 140 can be packaged inside the frame component 110, so that the extension portion of the first opening OP1 can shield the electrodes of the ultrasonic oscillating component 120 and provide an anti-EMI effect. Besides, the frame component 110 is formed of hard material whose hardness provides impact resistant protection to the ultrasonic oscillating component 120 and the adhesive component 140.

The frame component 110 has a second opening OP2 formed at one end away from the acoustic lens 130. To put it in greater details, the peripheral portion 111 has a second opening OP2 formed away from a position where the peripheral portion 111 and the inner extension portion 112 are connected. In the present embodiment, the size of the first opening OP1 is smaller than that of second opening OP2, but the present disclosure is not limited thereto. In an embodiment, the size of the first opening OP1 can be larger than that of second opening OP2. In another embodiment, the size of the first opening OP1 can be substantially equal to that of second opening OP2. The relationship between the size of the first opening OP1 and the size of the second opening OP2 depends on the angle of the junction of the peripheral portion 111 and the inner extension portion 112. The ultrasonic oscillating component 120 and the adhesive component 140 protrudes from the second opening OP2. That is, the frame component 110 can only cover a part of the ultrasonic oscillating component 120 and the adhesive component 140.

The ultrasonic oscillating component 120 may include an oscillating base 121 and a flexible circuit board 122. The acoustic lens 130 is in contact with the oscillating base 121 through the first opening OP1. The oscillating base 121 mainly includes a transducer capable of implementing mutual conversion of sound energy and electrical energy within the ultrasonic frequency range, and a wiring area for transduction signals. The inner extension portion 112 of the frame component 110, which serves as a partial mask to the wiring area of the oscillating base 121, achieves a shielding effect in the wiring area of the transduction signal and provides noise immunity to a side of the ultrasonic module 100 close to the acoustic lens 130. On the other hand, the partial masking provided to the oscillating base 121 by the inner extension portion 112 and the peripheral portion 111 of the frame component 110 provides the shielding effect to the ultrasonic oscillating component 120 and at least axial and radial protection against impact, hence avoiding elements being damaged due to external forces. Furthermore, since elements are covered by the frame component 110, the reliability is increased. The peripheral portion 111 of the frame component 110 provides not only masking for the wiring area on the flexible circuit board 122 and a shielding effect for the wiring area of the flexible circuit board 122, but also protection against radial impact and an increase in reliability.

The flexible circuit board 122 comprises at least one bendable spacer 122sp. Depending on the design, the quantity of spacers 122sp can be 1, 2, or 4, and the present disclosure is not limited thereto. The spacer 122sp bends and extends from its junction with the oscillating base 121. The spacers 122sp are arranged along an inner side of the frame component 110 and protrude from the second opening OP2. As indicated in FIG. 1B, the adhesive component 140 is accommodated in an interior volume surrounded and defined by the spacers 122sp of the flexible circuit board 122, and the adhesive component 140 can be solidly attached to the spacer 122sp without being protruded from the extension of the spacers 122sp.

Referring to FIG. 4, a schematic diagram of a frame component 110 is shown.

Each of the peripheral portion 111 and the inner extension portion 112 of the frame component 110 can be designed to have a wall thickness. That is, the peripheral portion 111 has a wall thickness 111t, and the inner extension portion 112 has a wall thickness 112t. In the present embodiment, the wall thickness 111t is larger than the wall thickness 112t, but the present disclosure is not limited thereto. The wall thickness 111t is smaller still can provide a certain degree of anti-EMI shielding effect given that the transception of the transduction signals of the oscillating base 121 remains stable. Since the wall is not directly opposite to the transceiving position of the transduction signal, the wall thickness 112t which is larger can enhance the anti-EMI shielding effect on the periphery of the ultrasonic module 100. In ultrasonic detection, normally the acoustic lens 130 and the oscillating base 121 are used to be in contact with the object to be tested, therefore the wall thickness 112t which is larger can enhance the impact resistance of the oscillating base 121 and avoid the oscillating base 121 being damaged or displaced due to impact.

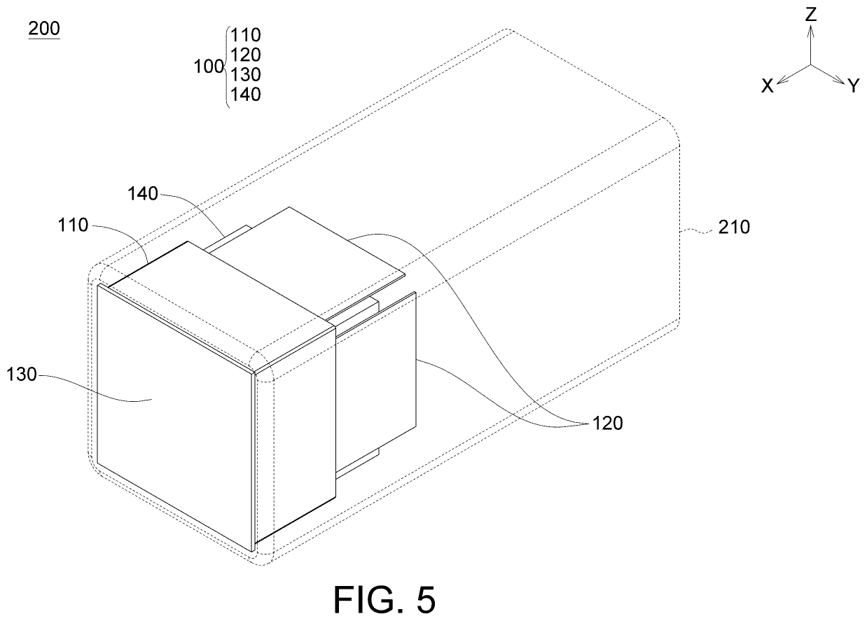

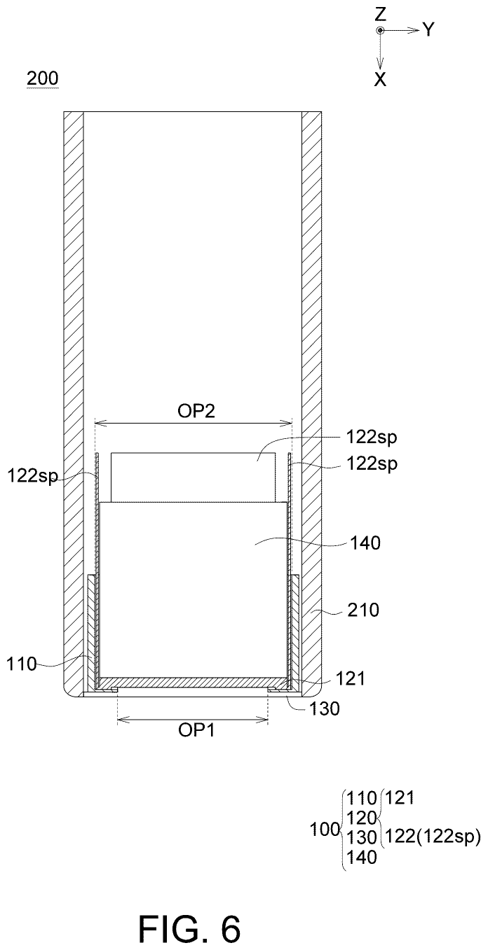

Refer to FIGS. 5 to 6. FIG. 5 is a schematic diagram of an ultrasonic probe 200 according to an embodiment. FIG. 6 is a top view cross-section of an ultrasonic probe 200 along the Z-axis.

The ultrasonic probe 200 can be realized by an ultrasonic transducer. The ultrasonic probe 200 comprises the said ultrasonic module 100 and the said casing 210, wherein the casing 210 is represented by denoted lines so that the ultrasonic module 100 inside the casing 210 can be illustrated. The casing 210 covers the ultrasonic module 100 and partially exposes the acoustic lens 130, so that the acoustic lens 130 can be used as a detection contact surface of the ultrasonic probe 200. The casing 210 can be formed of plastics. The casing 210 can be used a handle of the ultrasonic probe 200. The user can grip the handle when performing detection.

According to the ultrasonic module and the ultrasonic probe having the same disclosed in above embodiments of the present disclosure, the frame component, used as a middle frame, at least covers the ultrasonic oscillating component and provides an anti-EMI shielding effect. The frame component can further provide partial masking to the oscillating base of the ultrasonic oscillating component and achieve a shielding effect in the wiring area of the transduction signal without affecting the transception of the transduction signals.

While the invention has been described by way of example and in terms of the preferred embodiment(s), it is to be understood that the invention is not limited thereto. Based on the technical feature points embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An ultrasonic module, comprising:
a frame component;
an ultrasonic oscillating component accommodated in the frame component;
an acoustic lens disposed on the frame component; and
an adhesive component accommodated in the frame component;
wherein, the frame component is disposed between the acoustic lens and the ultrasonic oscillating component; the frame component has a first opening OP1 formed at one end adjacent to the acoustic lens, the ultrasonic oscillating component is disposed on a side of the first opening close to the adhesive component, and the acoustic lens is in contact with the ultrasonic oscillating component through the first opening.

2. The ultrasonic module according to claim 1, wherein the frame component has a second opening formed at a side away from the acoustic lens, and the ultrasonic oscillating component and the adhesive component protrude from the second opening.

3. The ultrasonic module according to claim 2, wherein a size of the first opening is smaller than a size of the second opening.

4. The ultrasonic module according to claim 1, wherein the frame component comprises a peripheral portion and an inner extension portion connected to the peripheral portion, the ultrasonic oscillating component and the adhesive component are accommodated in an interior volume surrounded and defined by the peripheral portion, and the inner extension portion has the first opening formed corresponding to the end adjacent to the acoustic lens.

5. The ultrasonic module according to claim 2, wherein the frame component comprises a peripheral portion and an inner extension portion connected to the peripheral portion, the ultrasonic oscillating component and the adhesive component are accommodated in an interior volume surrounded and defined by the peripheral portion, the inner extension portion forms the first opening, and the second opening is formed away from the junction of the peripheral portion and the inner extension portion.

6. The ultrasonic module according to claim 4, wherein each of the peripheral portion and the inner extension portion has a wall thickness, the wall thickness of the peripheral portion is larger than the wall thickness of the inner extension portion.

7. The ultrasonic module according to claim 1, wherein the ultrasonic oscillating component comprises an oscillating base and a flexible circuit board, the flexible circuit board comprises at least one bendable spacer, the acoustic lens is in contact with the oscillating base through the first opening, and the spacer is arranged along an inner side of the frame component.

8. The ultrasonic module according to claim 2, wherein the ultrasonic oscillating component comprises an oscillating base and a flexible circuit board; the flexible circuit board comprises at least one bendable spacer; the acoustic lens is in contact with the oscillating base through the first opening; the spacers are arranged along an inner side of the frame component and protrude from the second opening.

9. The ultrasonic module according to claim 7, wherein the adhesive component is accommodated in an interior volume surrounded and defined by the spacer.

10. The ultrasonic module according to claim 1, wherein the frame component is integrally formed of metal in one piece.

11. An ultrasonic probe, comprising:
an ultrasonic module, comprising:
a frame component;
an ultrasonic oscillating component accommodated in the frame component;
an acoustic lens disposed on the frame component; and
an adhesive component accommodated in the frame component; and
a casing covering the ultrasonic module and partially exposing the acoustic lens;
wherein, the frame component is disposed between the acoustic lens and the ultrasonic oscillating component; the frame component has a first opening formed at one end adjacent to the acoustic lens; the ultrasonic oscillating component is disposed on a side of the first opening close to the adhesive component; the acoustic lens is in contact with the ultrasonic oscillating component through the first opening.

12. The ultrasonic probe according to claim 11, wherein the frame component has a second opening formed at a side away from the acoustic lens; the ultrasonic oscillating component and the adhesive component protrude from the second opening.

13. The ultrasonic probe according to claim 12, wherein the size of the first opening is smaller than that of the second opening.

14. The ultrasonic probe according to claim 11, wherein the frame component comprises a peripheral portion and an inner extension portion connected to the peripheral portion; the ultrasonic oscillating component and the adhesive component are accommodated in an interior volume surrounded and defined by the peripheral portion; the inner extension portion has the first opening formed corresponding to the end adjacent to the acoustic lens.

15. The ultrasonic probe according to claim 12, wherein the frame component comprises a peripheral portion and an inner extension portion connected to the peripheral portion; the ultrasonic oscillating component and the adhesive component are accommodated in an interior volume surrounded and defined by the peripheral portion; the inner extension portion forms the first opening; the second opening is formed away from the junction of the peripheral portion and the inner extension portion.

16. The ultrasonic probe according to claim 14, wherein each of the peripheral portion and the inner extension portion has a wall thickness; the wall thickness of the peripheral portion is larger than that of the inner extension portion.

17. The ultrasonic probe according to claim 11, wherein the ultrasonic oscillating component comprises an oscillating base and a flexible circuit board; the flexible circuit board comprises at least one bendable spacer; the acoustic lens is in contact with the oscillating base through the first opening; the spacers are arranged along an inner side of the frame component.

18. The ultrasonic probe according to claim 12, wherein the ultrasonic oscillating component comprises an oscillating base and a flexible circuit board; the flexible circuit board comprises at least one bendable spacer; the acoustic lens is in contact with the oscillating base through the first opening; the spacers are arranged along an inner side of the frame component and protrude from the second opening.

19. The ultrasonic probe according to claim 17, wherein the adhesive component is accommodated in an interior volume surrounded and defined by the spacer.

20. The ultrasonic probe according to claim 11, wherein the frame component is integrally formed of metal in one piece.
